(19) United States
(12) Patent Application Publication
(10) Pub. No.: US 2004/0159629 A1
(43) Pub. Date: Aug. 19, 2004

(54) MEM device processing with multiple material sacrificial layers

(75) Inventor: Heinz H. Busta, Park Ridge, IL (US)

Correspondence Address: PHYLLIS T. TURNER-BRIM, ESQ., LAW DEPARTMENT, CABOT MICROELECTRONICS CORPORATION, 870 NORTH COMMONS DRIVE, AURORA, IL, 60504, US

(73) Assignee: Cabot Microelectronics Corporation

(21) Appl. No.: 10/779,226

(22) Filed: Feb. 13, 2004

Related U.S. Application Data
(60) Provisional application No. 60/448,219, filed on Feb. 19, 2003.

(51) Int. Cl. B44C 1/22

(52) U.S. Cl. 216/22

(57) ABSTRACT

The invention relates to processes for preparing microelectromechanical (MEM) devices. Multimaterial sacrificial layers are used in the processes of the invention, thus allowing for the fabrication of sophisticated devices. The invention also relates to MEM devices prepared according to the processes of the invention and to pre-MEM devices.

### BACKGROUND OF THE INVENTION

1. Field of the Invention

This invention relates in general to microelectromechanical (MEM) devices and more particularly to processes for manufacturing MEM devices. The invention also relates to pre-microelectromechanical devices (pre-MEM devices).

2. Description of the Related Art

MEM devices are fabricated using integrated circuit (IC) and silicon micromachining technology. In a typical surface micromachining process, a plurality of layers of structural material, such as polycrystalline silicon (also termed polysilicon) and a plurality of sacrificial support layers are alternately deposited and photolithographically patterned on a substrate. The sacrificial layers, which physically support the structure layers, are removed in a single etching step to provide the free-standing features of a MEM device. Up to three or four layers or more of structural material can be used to form surface micromachined MEM devices which can include numerous interconnected moveable features such as gears, wheels, carriages, linkages, hinges, etc.

Generally, a single type of removable material is used as the sacrificial layers in the manufacture of MEM devices, thus allowing all the sacrificial layers to be removed in one step. However, using a single sacrificial material limits the types of features that can be placed on a device. For instance, a device that is in the process of manufacture may contain an underlying layer that has greater sensitivity to the etching process (used to remove the sacrificial material) than other structural layers, and exposure of the underlying layer to the etchant may damage or destroy the layer. Using a single type of sacrificial material as the sacrificial layers for all the features of the device would not provide protection for the sensitive underlying layer, and the sensitive layer would be exposed to the etchant during removal of the sacrificial materials.

Thus, current manufacturing processes relying on single material sacrificial layers provide limited flexibility in the manufacture of MEM devices. A need exists, therefore, for new manufacturing processes and pre-MEM devices that allow greater flexibility in MEM device manufacture.

### BRIEF SUMMARY OF THE INVENTION

In one aspect, the invention provides a process for fabricating a MEM device comprising depositing and patterning on a substrate one or more mechanical layers and a plurality of sacrificial layers; and removing the plurality of sacrificial layers, wherein at least two of the plurality of sacrificial layers are selected from different materials.

In another aspect, the invention provides a process for fabricating a MEM device feature comprising depositing on a substrate a plurality of sacrificial layers; photoshaping a cavity representing a MEM device feature into one or more of the plurality of sacrificial layers; depositing a mechanical layer onto the cavity; planarizing the mechanical layer; and removing the sacrificial layers, wherein at least two of the plurality of sacrificial layers are selected from different materials.

In another aspect, the invention provides a pre-MEM device comprising: one or more mechanical layers; and a plurality of sacrificial layers, wherein at least two of the plurality of sacrificial layers are selected from different materials.

### BRIEF DESCRIPTION OF THE DRAWINGS

FIG. 1 depicts one embodiment of a pre-MEM device of the invention.

FIG. 2 depicts a device in which one of two sacrificial layers has been removed.

FIG. 3 depicts a device in which all the sacrificial layers have been removed.

FIG. 4 depicts a process for fabricating a MEM device feature according to one embodiment of the invention.

### DETAILED DESCRIPTION OF THE PREFERRED EMBODIMENT

As used herein, “pre-microelectromechanical device” or “pre-MEM device” refers to a MEM device in which some or all of the sacrificial layers have not yet been removed.

As used herein, “feature” or “features” refers to the mechanical and/or electrical components of a MEM device.

As used herein, “plurality of sacrificial layers” refers to two or more sacrificial layers.

As used herein, “multimaterial sacrificial layers” refers to a plurality of sacrificial layers in which at least two of the sacrificial layers are made of different materials. For instance, four sacrificial layers on a substrate in which three layers are silicon dioxide and one layer is polyimide are designated “multimaterial sacrificial layers.”

Known methods for fabricating MEM devices use single material sacrificial layers throughout the pre-MEM device structure. Using single material sacrificial layers, however, limits the design options available in fabricating advanced MEM devices. The processes and pre-MEM devices of this invention use multiple material sacrificial layers, which provide greater design options and flexibility in the fabrication of MEM products.

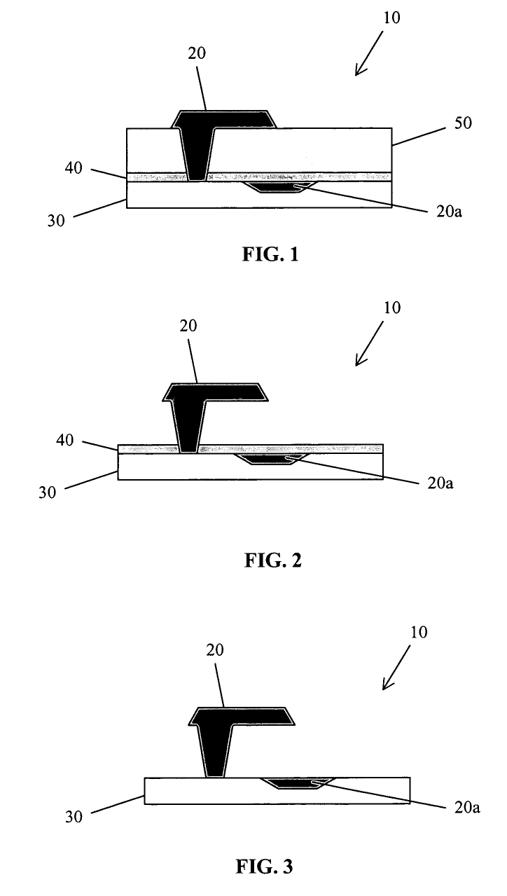

In one aspect, the invention relates to a process for fabricating a MEM device. In this process, a sacrificial layer or a mechanical layer is deposited and patterned on a substrate. Electrical features may be present on or inlayed in the substrate. A second sacrificial or mechanical layer is then deposited and patterned on the substrate, on the first layer of sacrificial or mechanical material, or on both. The deposition and patterning of sacrificial and mechanical layers is repeated as necessary to provide the desired MEM device design. The sacrificial layers are then removed by etching to leave the free standing mechanical features. At least two of the sacrificial layers used in the deposition and patterning step are selected from different materials, thus providing a pre-MEM device containing multimaterial sacrificial layers. This process is illustrated in FIGS. 1-3.

FIG. 1 schematically depicts a pre-MEM device 10 in which features 20 and a first and second sacrificial layers 40 and 50 have been patterned on a substrate 30. A second feature 20a, which maybe electrical or mechanical, is inlayed in substrate 30. In the embodiment shown, feature 20 is supported by first and second sacrificial layers 40 and 50, and feature 20a is protected by sacrificial layer 40. The sacrificial layers are then removed, either in separate etching steps (FIG. 2) or in the same etching step (FIG. 3).

FIG. 2 depicts a device in which sacrificial layer 50 has been selectively removed without removal of sacrificial layer 40. As discussed below, sacrificial layer 40 in this embodiment serves to protect feature 20a from the etching process used to remove sacrificial layer 50. The remaining sacrificial layer 40 can be removed by an etching process that is not corrosive to feature 20a, to provide a MEM device, as shown in FIG. 3. Alternatively, sacrificial layers 40 and 50 can be removed in the same etching step to provide the MEM device shown in FIG. 3.

FIGS. 1-3 depict embodiments of the invention having two sacrificial layers and two features. The invention, however, is not limited to methods and devices comprising only two sacrificial layers or only two features, and encompasses devices having any number of features and sacrificial layers.

There are several advantages of using multimaterial sacrificial layers according to the invention. One advantage is that sacrificial layers can be used with the purpose of protecting sensitive features from detrimental processes that might otherwise damage or destroy those features. For instance, if feature 20a in FIG. 1 is an electrical feature which is sensitive to etching processes for removing common sacrificial layers such as silicon dioxide, then the feature can be protected by sacrificial layer 40, which is selectively etchable by a process not damaging to feature 20a. Sacrificial materials better suited for the formation of the MEM device structure, such as silicon dioxide, may then be used to form layer 50. Once sacrificial layer 50 has been removed using the etching process appropriate to that material (as in FIG. 2), sacrificial layer 40 is removed by an etching process that is not damaging to feature 20a, substrate 30 or feature 20.

Another example of the advantages of using multimaterial sacrificial layers is as follows. If feature 20a in FIG. 1 is sensitive to the process of depositing sacrificial layer 50, for instance, if feature 20a is a copper line and layer 50 is silicon dioxide (the copper line might be oxidized during the deposition of the silicon oxide), then the feature can be protected by first depositing a sacrificial layer 40 on feature 20(a)using a deposition process that is not damaging to the feature. Once feature 20a is protected, sacrificial layer 50 can be deposited without damaging feature 20a. The sacrificial layers can then be removed in a single etching step (FIG. 3) or in separate etching steps (FIGS. 2 and 3).

Another significant advantage of using multimaterial sacrificial layers in the manufacture of MEM devices is the reduction or elimination of stiction. Stiction is the sticking of freely standing microstructures to the substrate. Stiction can occur immediately after a wet sacrificial etch process, whereby capillary force from the rinse liquid causes attraction between suspended elements of the device and the underlying substrate, causing the elements to adhere to the underlying substrate.

In the invention, stiction can be reduced by using multimaterial sacrificial layers. A top layer, for instance 50 in FIG. 1, can be of a common sacrificial material, such as silicon oxide. A lower layer, for instance 40 in FIG. 1, can be of a sacrificial material that is etchable by dry etching techniques, such as polyimide, but not etchable by the wet etching process used to remove layer 50. During fabrication, layer 50 is etched down to layer 40 by wet etching. Etching stops at layer 40. Layer 40 is then removed by dry etching, such as oxygen plasma etching, which does not give rise to stiction. If the lower layer is thinner than the upper layer, processing time in the plasma etcher can be significantly reduced while still providing the no-stiction advantage of the plasma etcher. In this embodiment, the relative thicknesses of the upper and lower sacrificial layers will depend on various factors including the design of the MEM feature. As an example, the lower layer can be about 0.1 micrometers to about 2 micrometers in thickness, and the upper layer can be about 0.1 micrometers to about 15 micrometers in thickness.

According to the invention, multimaterial sacrificial layers are also advantageously used in other processes for preparing MEM devices. Thus, in another aspect, the invention relates to a process for preparing a MEM device by a chemical mechanical planarization (“CMP”) damascene process. By planarizing certain substrate surfaces during the MEM device fabrication process, MEM devices can be produced with novel performance and reliability characteristics.

The CMP process was initially developed to enable the manufacture of next-generation Integrated Circuits (ICs) by ensuring that each interconnect level in a semiconductor chip is as flat and smooth as possible before the next level is built. Damascene processes are frequently employed in semiconductor manufacturing for forming inlayed features such as interconnects, conductive lines, contacts or vias. To form a conventional damascene structure, a dielectric layer is deposited over a substrate having a conductive region thereon and then a polishing stop layer is formed over the dielectric layer. An opening is formed in the polishing stop layer and the dielectric layer. The opening exposes a portion of the conductive region in the substrate. A metallic layer is formed over the substrate and completely fills the opening. Finally, CMP is conducted to remove excess metallic material outside the opening.

In the present invention, a damascene process is used to prepare MEM device structures. In this process, use is made of multimaterial sacrificial layers. As discussed above, using multimaterial sacrificial layers provides flexibility to the MEM device fabrication process, such as allowing selective etching of the sacrificial layers. This greater flexibility permits increased precision in the formation of MEM device features and is particularly useful where a feature having a contoured surface is desired. An example of such a feature is a lever having a ribbed surface. A ribbed surface increases the rigidity of a lever which can provide certain advantages such as reduced stiction.

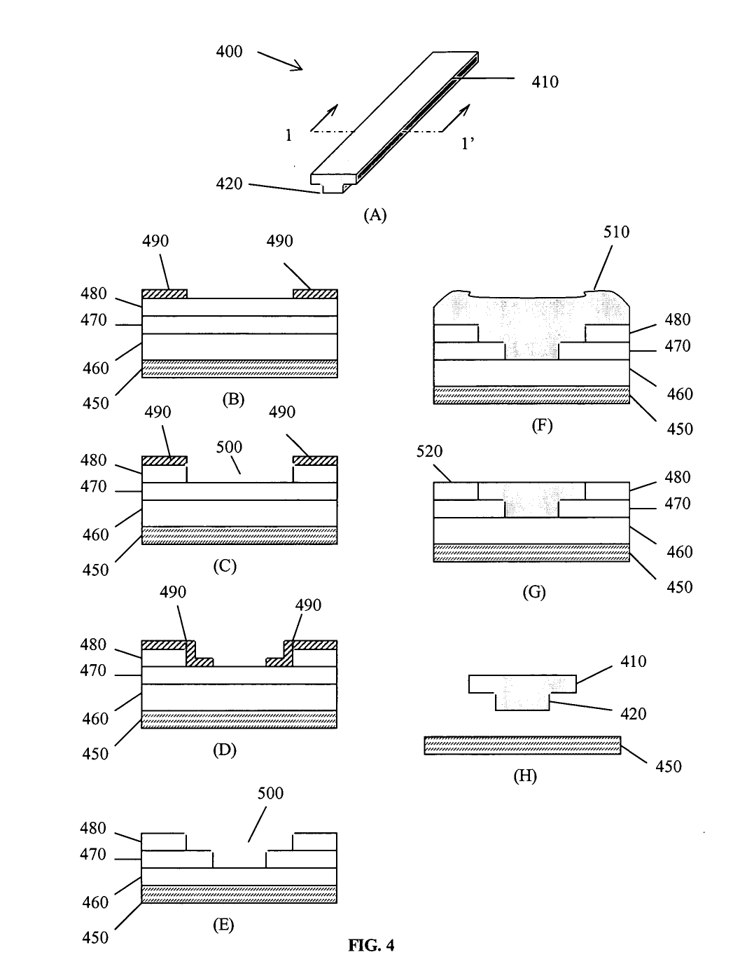

Although not limited to ribbed levers, the damascene process of the invention and its advantages over conventional processes can be demonstrated by reference to FIGS. 4(A)-4(H). FIGS. 4(A)-4(H) show the arm portion of a ribbed lever and the various steps in a damascene process for preparing the ribbed lever.

Referring now to FIG. 4(A), an arm 400 of a ribbed lever is shown, as illustrative of one MEM device feature that can be prepared according to the process depicted in FIGS. 4(B) to 4(H). The arm 400 comprises a top portion 410 and a rib portion 420. The anchor part of the ribbed lever is not shown. FIGS. 4(B)-4(H) show a view along the 1-1′ cut of FIG. 4(A).

FIG. 4(B) depicts a substrate 450 on which are deposited sacrificial layers 460, 470, and 480. In this aspect of the invention, immediately adjacent sacrificial layers are selected from different materials having different etching properties. Thus, in FIG. 4(B) layer 480 is a different material from layer 470, and layer 470 is a different material from layer 460. Layer 460 and 480 can be of the same or different material since these layers are not immediately adjacent. The depth of each of the sacrificial layers will depend on the dimensions of the feature being fabricated. In the case of a ribbed lever, each layer 460, 470, 480 is independently preferably 1-2 microns.

Photoshaping of the sacrificial layers into a cavity or mold 500 representing the MEM device feature is carried out as follows. A photoresist material 490 is deposited on sacrificial layer 480 and patterned by standard IC techniques into the desired pattern. Here the photoresist is patterned as the top portion 410 of the lever arm 400. Etching of the exposed region of sacrificial layer 480 provides a cavity 500, as shown in FIG. 4(C). Because the immediately adjacent sacrificial layer 470 is not readily etched by the etching process used to etch the exposed region of layer 480, etching stops when it reaches layer 470. Thus, by using adjacent sacrificial layers having different etching properties, the etch can give selectivity to one or more of the layers and very precise etching depth can be achieved. If layers 470 and 480 were of the same material and possessed the same etching properties, then some etch back into layer 470 would be expected, and the dimensions of cavity 500 would not be as readily controllable as when sacrificial layers of different materials are used.

Further photoshaping by application of photoresist and etching provides cavity 500 in the shape of the lever arm 400, as shown in FIGS. 4(D) and 4(E). Once cavity 500 has been formed, an optional adhesion layer (not shown in the Figures) is deposited over the top surface of the layer 480 and the cavity 500. Preferably, the adhesion layer comprises 100 to 200 Angstroms of Ta, Cr, TiW, or other like adhesion layer material. After deposition of the adhesion layer, if one is used, a mechanical layer 510 is deposited along the etched out cavity 500, as shown in FIG. 4(F). In the embodiment shown, about 7-10 microns of mechanical layer 510 are deposited.

Optionally, the rib portion 420 of the lever can be of a different mechanical layer material than the top portion 410 of the lever. In this case, a CMP planarization of the top surface of the rib is conducted after deposition of the rib material but before deposition and photoetching of layer 480. Following planarization, layer 480 is deposited, photoshaped, and then the top portion of the layer deposited.

After deposition of mechanical layer 510, a CMP process is utilized to planarize the top surface of the layer, yielding the planarized layer, as shown in FIG. 4(G). The sacrificial layers 460, 470 and 480 are then etched away, either in one step or in separate steps, to provide the lever arm as shown in FIG. 4(H).

Examples of polishing compositions useful in the CMP process are described, for instance, in U.S. Pat. Nos. 6,447,371, 6,432,828, 5,527,423, each of which is incorporated herein by reference. CMP slurries are also commercially available.

In the processes of the invention, mechanical layer materials include, but are not limited to, polycrystalline silicon, metals such as copper and tantalum, silicon nitride, silicon carbide, or bi-morphal materials (i.e., including two layers). Other mechanical materials are known in the art and can be used.

The sacrificial layers can be selected from, for example, silicon dioxide, polyimide, metals such as aluminum and copper, polymethylmethacrylate (PMMA) and other plastics, and other photoresist materials, and the like. Other sacrificial layer materials are well known in the art and can also be used. Typically, sacrificial layers are about 0.1 micrometers to about 15 micrometers in thickness.

The substrate material on which the mechanical and sacrificial layers are deposited and/or patterned can include for instance single crystal silicon, polycrystalline silicon, alumina, ceramic materials, fused silica, and quartz. Other substrate materials known in the art can be used. Electrical and/or mechanical features may be present in or on the substrate and thus form a part of the substrate.

Sacrificial and mechanical layers can be deposited or formed on a substrate by, for example, spin-on coating, sputtering, e-beam evaporation, chemical vapor deposition (CVD), plasma assisted CVD, and spraying, and the like.

Known techniques can be used to pattern the sacrificial and mechanical layers being deposited on a substrate. Typically, a layer of polymeric photoresist material is deposited, for example by spin coating, over the sacrificial or mechanical layer on the substrate. The resist is masked and irradiated through the mask. The resist either polymerizes in the exposed areas (negative resist) or prevents polymerization in the areas exposed (positive resist). The non-polymerized area of the resist is removed, e.g., in a developer solution, to provide the patterned resist. The exposed sacrificial or mechanical layer can then be etched in the areas not covered by the resist to provide the desired pattern.

Once the desired pattern of mechanical and sacrificial layers has been deposited and patterned, the sacrificial layers are removed to release the mechanical structures from surrounding materials. This is accomplished using a release etch which is selective to the sacrificial material, leaving the mechanical material largely unaffected. Often a long release etch is required to undercut mechanical materials for a distance many times greater than the thickness of the sacrificial material. In many cases, etch holes are included in the mechanical material in an attempt to minimize the required undercutting and thereby shorten the release etch.

Etching processes used for removal of sacrificial layers are dependent on the material from which the sacrificial layer is made. For instance, silicon dioxide can be removed by a wet etch process using hydrofluoric acid or by a dry plasma process using CF4/O2 gas. Polyimide can be removed by a wet etch using the manufacturer's recommended solution, or by dry etch in an oxygen plasma. Metals can be removed by dry or wet chemical methods. PMMA and other photoresist materials can be removed by dry or wet chemical methods. In the process of the invention, the sacrificial layers can be removed together or independently as discussed above.

It should be understood that the foregoing disclosure emphasizes certain specific embodiments of the invention and that all modifications or alternatives equivalent thereto are within the spirit and scope of the invention as set forth in the appended claims.

1. A pre-MEM device comprising:
one or more mechanical layers; and
a plurality of sacrificial layers,
wherein at least two of the plurality of sacrificial layers are selected from different materials.

2. The pre-MEM device of claim 1 wherein the substrate is single crystal silicon or polycrystalline silicon.

3. The pre-MEM device of claim 1 wherein the one or more mechanical layers are independently selected from polycrystalline silicon, a metal, silicon nitride, and silicon carbide.

4. The pre-MEM device of claim 1 wherein the plurality of sacrificial layers are selected from the group consisting of silicon dioxide, a polyimide, a metal, and a photoresist material.

5. The pre-MEM device of claim 1 wherein the plurality of sacrificial layers comprises two sacrificial layers.

6. The pre-MEM device of claim 1 wherein the one or more mechanical layers and the plurality of sacrificial layers are deposited and patterned on a substrate.

7. A process for fabricating a MEM device comprising the steps of:
depositing and patterning on a substrate one or more mechanical layers and a plurality of sacrificial layers; and
removing the plurality of sacrificial layers,
wherein at least two of the plurality of sacrificial layers are selected from different materials.

8. The process of claim 7 wherein the substrate is single crystal silicon or polycrystalline silicon.

9. The process of claim 7 wherein the one or more mechanical layers are independently selected from polycrystalline silicon, a metal, silicon nitride, and silicon carbide.

10. The process of claim 7 wherein the plurality of sacrificial layers are selected from the group consisting of silicon dioxide, a polyimide, a metal, and a photoresist material.

11. The process of claim 7 wherein the plurality of sacrificial layers comprises two sacrificial layers.

12. The process of claim 7 wherein the plurality of sacrificial layers are removed in a single etching step.

13. The process of claim 7 wherein the plurality of sacrificial layers are selectively removed in separate etching steps.

14. A MEM device prepared by the fabrication process of claim 7.

15. A process for fabricating a MEM device feature comprising the steps of:
depositing a plurality of sacrificial layers on a substrate;
photoshaping one or more of the plurality of sacrificial layers into a cavity representing a MEM device feature;
depositing a mechanical layer onto the cavity;
planarizing the mechanical layer; and
removing the sacrificial layers,
wherein at least two of the plurality of sacrificial layers are selected from different materials.

16. The process of claim 15 wherein the substrate is single crystal silicon or polycrystalline silicon.

17. The process of claim 15 wherein the mechanical layer is selected from polycrystalline silicon, a metal, silicon nitride, and silicon carbide.

18. The process of claim 15 wherein the plurality of sacrificial layers are selected from the group consisting of silicon dioxide, a polyimide, a metal, and a photoresist material.

19. The process of claim 15 wherein the plurality of sacrificial layers comprises two sacrificial layers.

20. The process of claim 15 wherein the plurality of sacrificial layers are removed in a single etching step.

21. A MEM device feature prepared by the process of claim 15.
